(19) United States
(12) Patent Application Publication
(10) Pub. No.: US 2025/0166363 A1
(43) Pub. Date: May 22, 2025

(54) SYSTEMS AND METHOD FOR END-TO-END ENTERPRISE COMPUTER VISION

(71) Applicant: ALWAYSAI, INC., Cardiff by the Sea, CA (US)

(72) Inventors: Steven GRISET, Atascadero, CA (US); Eric VANBUHLER, San Diego, CA (US); Justin RICH, Encinitas, CA (US)

(21) Appl. No.: 18/957,418

(22) Filed: Nov. 22, 2024

Related U.S. Application Data
(60) Provisional application No. 63/602,313, filed on Nov. 22, 2023.
(60) Provisional application No. 63/602,360, filed on Nov. 22, 2023.

(51) Int. Cl. G06V 10/778

(52) U.S. Cl. CPC G06V 10/778

(57) ABSTRACT

An end-to-end enterprise computer vision system develops a software application performing one or more computer vision functions; and processes analytics from one or more computing vision functions. The analytics provide real-time insight associated with operations of an enterprise.

### REFERENCE TO RELATED APPLICATIONS

The present application claims priority to U.S. Provisional Patent Application No. 63/602,313, filed Nov. 22, 2023 and titled “SYSTEMS AND METHOD FOR END-TO-END ENTERPRISE COMPUTER VISION,” and U.S. Provisional Patent Application No. 63/602,360, filed Nov. 22, 2023 and titled “SYSTEMS AND METHOD FOR INCREMENTAL LEARNING FOR OBJECT DETECTION,” which are incorporated herein by reference in their entireties.

### SUMMARY

Systems and methods implementing end-to-end enterprise computer vision are disclosed herein. The disclosed examples include a system that implements computer vision capabilities, such as object detection, facial detection and the like, in a manner that can improve the overall operation of a business or enterprise by extracting real-time actionable insight (e.g., using the computer vision functions) and identifying business-related problems (e.g., inefficiencies, anomalies, and productivity issues). The end-to-end enterprise computer vision systems and methods can leverage an existing camera infrastructure of a business alongside edge devices and/or cloud-based resources to capture and process images and video data. Using this collected image and video data, the end-to-end enterprise computer vision system implements enterprise-grade models to provide computer vision capabilities that support enhanced and automated detection for a business that is beyond human vision. Applications are written to leverage these models and generate real-time or historic data that can be used to improve business processes and provide valuable insights to business owners and operators.

### BRIEF DESCRIPTION OF DRAWINGS

The technology disclosed herein, in accordance with one or more various embodiments, is described in detail with reference to the following figures. The drawings are provided for purposes of illustration only and merely depict typical or example embodiments of the disclosed technology. These drawings are provided to facilitate the reader's understanding of the disclosed technology and shall not be considered limiting of the breadth, scope, or applicability thereof. It should be noted that for clarity and ease of illustration these drawings are not necessarily made to scale.

FIG. 1 illustrates an end-to-end enterprise computer vision system, in accordance with some of the embodiments disclosed herein.

FIG. 2 illustrates an example computing environment for a developer experience related to the end-to-end enterprise computer vision system, in accordance with some of the embodiments disclosed herein.

FIG. 3A illustrates an example of image data that can be employed in training an Artificial Intelligence (AI)-based model executed by the end-to-end enterprise computer vision system, in accordance with some of the embodiments disclosed herein.

FIG. 3B illustrates an example of outputs generated by the end-to-end enterprise computer vision system from training the AI-based model in relation to the image data shown in FIG. 3A, in accordance with some of the embodiments disclosed herein.

FIG. 4 illustrates a conceptual diagram of a training phase and an inference phase related to the AI-based model employed by the end-to-end enterprise computer vision system, in accordance with some of the embodiments disclosed herein.

FIG. 5 illustrates a method for implementing end-to-end enterprise computer vision, in accordance with some of the embodiments disclosed herein.

The figures are not intended to be exhaustive or to limit the invention to the precise form disclosed. It should be understood that the invention can be practiced with modification and alteration, and that the disclosed technology be limited only by the claims and the equivalents thereof.

### DETAILED DESCRIPTION

Computer vision is a field of artificial intelligence (AI) that focuses on enabling computers to interpret and understand visual information from the world, in a manner that is similar to humans with their vision. Computer vision often involves developing algorithms and systems that can analyze, process, and make sense of visual data from images and videos.

Computer vision has numerous applications across various industries, including autonomous vehicles, healthcare (e.g., medical image analysis), security and surveillance, agriculture, retail (e.g., cashier less stores), and the like. Advances in machine learning, improved processor capabilities, and the availability of large datasets have significantly accelerated progress in the field of computer vision in recent years. For example, in the realm of business enterprise, computer vision can be leveraged to allow businesses to detect people, objects, and events in real-time. Computer vision can provide detection for business applications that is substantially improved in comparison to human monitoring (e.g., human staff). A computer vision platform may be able to utilize AI to capture more accurate data to target inefficiencies, detect anomalies, and better address productivity issues for an enterprise.

For many businesses, there are operational problems that can persist, which would otherwise be solved by having accurate and targeted insight surrounding labor, materials, and services of the business. To address these issues, the disclosed embodiments are directed to an end-to-end enterprise computer vision system and techniques that implement enhanced computer vision to provide real-time visual insights to facilitate practical operational improvements across industries. As described herein, an end-to-end enterprise computer vision system detects objects, people, and events in real-time for various enterprise applications, in a manner that can improve efficiency of business operations and enhance return on investment (ROI). Furthermore, a distinct technique for implementing end-to-end enterprise computer vision is disclosed that involves several stages, including: data collection; data annotation; model training; application development; application deployment; run-time inferencing; and analytics gathering. Accordingly, the end-to-end enterprise computer vision system and techniques operate as a practical AI solution that realizes several advantages, such as integrated data and model training pipeline, easy application deployment, seamless integration with existing infrastructure, and unprecedented analytics.

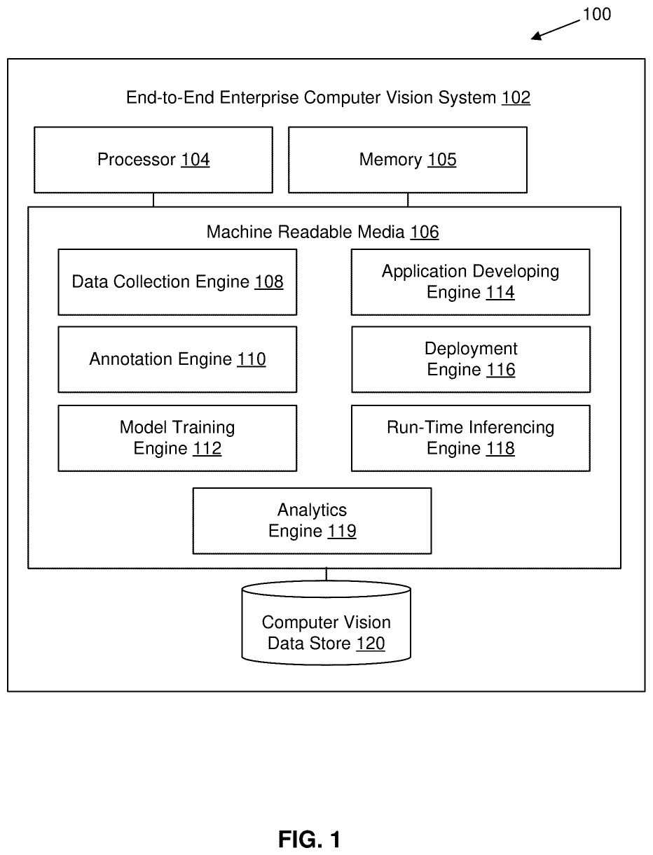

FIG. 1 illustrates a system for end-to-end enterprise computer vision, in accordance with some of the embodiments disclosed herein. In example 100, end-to-end enterprise computer vision system 102 is configured to implement computer vision capabilities, such as object detection, facial detection and the like, in manner that can improve the overall operation of a business or enterprise by extracting real-time actionable insight (from computer vision) and identifying business-related problems (e.g., inefficiencies, anomalies, and productivity issues). The end-to-end enterprise computer vision system 102 can leverage an existing camera infrastructure of a business alongside edge devices and/or cloud-based resources to capture and process images and video. Using this collected image and video data, the end-to-end enterprise computer vision system 102 implements enterprise-grade models and applications to provide computer vision capabilities that support enhanced and automated detection for a business that is beyond human vision. In other words, the end-to-end enterprise computer vision system 102 is configured to leverage computer vision to generate robust insight to the operations of a business or enterprise. As an example, the end-to-end enterprise computer vision system 102 may be utilized by a business to audit its processes to gain an understanding of inefficiencies, bottlenecks, and further identify points of improvement. Examples of enterprise-related processes that can be monitored, tracked, and automated by the end-to-end enterprise computer vision system 102 include, but are not limited to: backend operations; labor productivity and shift variances; machine use; occupancy; foot and/or car traffic; Personal Protective Equipment (PPE) compliance; safety protocols; defect detection; activity monitoring; and the like. The end-to-end enterprise computer vision system 102 may be implemented as a server computer with processor 104 being an efficient processor like a graphics processing unit (GPU), although such limitations are not required with each embodiment of the disclosure.

Processor 104 may comprise a general-purpose or special-purpose processing engine such as, for example, a microprocessor, controller, or other control logic. Processor 104 may be connected to a bus, although any communication medium can be used to facilitate interaction with other components of the end-to-end enterprise computer vision system 102 or to communicate externally.

Memory 105 may comprise random-access memory (RAM) or other dynamic memory for storing information and instructions to be executed by processor 104. Memory 105 might also be used for storing temporary variables, parameters or other intermediate information during execution of instructions to be executed by processor 104. Memory 105 may also comprise a read only memory (“ROM”) or other static storage device coupled to a bus for storing static information and instructions for processor 104.

Machine readable media 106 may comprise one or more interfaces, circuits, engines, and modules for implementing the functionality discussed herein. Machine readable media 106 may carry one or more sequences of one or more instructions processor 104 for execution. Such instructions embodied on machine readable media 106 may enable the end-to-end enterprise computer vision system 102 to perform features or functions of the disclosed technology as discussed herein. For example, the interfaces, circuits, and modules of machine-readable media 106 may comprise, for example, a data collection engine 108, annotation engine 110, model training engine 112, application developing engine 114, application deployment engine 116, run-time inferencing engine 118, and analytics engine 119. Computer vision data store 120 may store information related to computer vision, as well as other information associated with image processing and/or artificial intelligence.

Data collection engine 108 is configured to perform dataset management functions, for instance collecting and organizing image data and/or video data (and annotations) for further analysis by the system 102. In some embodiments, the data collection engine 108 collects images and video from at least one deployment location, where the images and video are then uploaded to the end-to-end enterprise computer vision system 102. The data collection engine 108 consumes video streams from cameras and hosts which publish them. For example, a business may already have monitoring cameras installed throughout their facilities. The data collection engine 108 can be configured to remotely collect the images and videos that are captured by the business' established camera infrastructure, which is ultimately utilized to drive the system's 102 computer vision capabilities. In some implementations, in addition to (or in lieu of) data collected from business deployment points, the collection engine 108 may generate synthetic data or procure already existing image and/or video data that can then be used for further processing by the system 102. As an example, in such cases where a business has no cameras deployed, the data collected engine 108 may collect video from similar locations or facilities that demonstrate comparable operations to the business for analysis.

In some embodiments, the data collection engine 108 can comprise components that are capable of drawing, storing, and display dimensions for a bounding box. For instance, the data collected engine 108 may include a specialized software application that feeds the collected data to the other elements of the system 102, and communicates to hardware resources such as cameras, edge devices, and cloud hosts that can be leveraged to collect and capture video and/or images. In some embodiments, the data collection engine 108 is configured to extract frames from video data that is collected.

Annotation engine 110 is configured to implement enhanced data annotation functions ultimately to support the system's 102 computer vision capabilities. For instance, the annotation engine 110 can perform labeling (or annotating) of various points of interest or objects in the image and/or video data that is collected by the data collection engine 108. Through annotation, the annotation engine 110 generates a dataset (e.g., for deep learning, computer vision functions) from the images and videos that have been obtained by the system 102. The annotation engine 110 is configured to annotate new or existing data, utilizing components such as classes/labels, bounding boxes, and polygons. The annotation engine 110 may employ auto annotation, manual annotation, and data cleaning approaches to accomplish data annotation. In some embodiments, the annotation engine 110 can integrate tools such as dataset management and the Computer Vision Annotation Tool (CVAT) for video and image annotation. The annotation engine 110 can also further annotate data that has already been collected with annotations, to ensure that quality of the labeling is sufficient for AI-based processing, such as model training.

Model training engine 112 is configured to perform AI-based model training. According to the embodiments, the model training engine 112 trains models for image classification and/or object detection that supports the system's 102 computer vision capabilities. The model training engine 112 can train models based on the annotated datasets generated by the annotation engine 110, such that the models have enhanced performance across diverse use cases. For example, the model training engine 112 receives the annotated data (a combination of images/video and corresponding annotation files) and feeds them through neural networks, where the neural networks learn from repeatedly recognizing objects over a plurality of examples from the dataset and thusly are able to perform similar object detection for future images. The model training engine 112 continues the training process until a level of accuracy or performance that is deemed acceptable is achieved for the model, which allows the neural network to learn complex patterns and relationships within the data, making the model capable of making predictions and classifications on new (or unseen) data. In some implementations, the model training engine 112 may employ frameworks, such as Python and Tensorflow.

The model training engine 112 can implement several different model architectures that are each configured and optimized for specific applications. The model architectures implemented by the model training engine 112 can include: YOLOv4 which includes hyper parameters configured for static applications and thus can be used for multi-object detection and is optimized for object detection in less complex environments where conditions have less variability (e.g., fixed camera in a fixed environment like a retail store), and having easy training and high efficiency in predictable conditions; YOLOv4 which includes hyper parameters configured for dynamic applications and thus can be optimal for applications that require detection of multiple object classes and object detection in complex environments (e.g., changing conditions and backgrounds), and having high performance and reliability; YOLOv3 which includes hyper parameters configured for simple applications and thus can be optimal for simple environments that have fewer items or objects classes to detect, and having high reliability in real-world use cases; and Mobilenet SSD. By leveraging different model architectures for specific implementations, the model training engine 112 can provide models that are ready for real-world deployments, while using a model training process that is simplified and streamlined. Accordingly, the model training engine 112 can execute a model training process that is fast (e.g., rapid training of models), requires less data for high quality performance, easily converts to formats that can be used with hardware accelerators and edge devices, and ensures enterprise level inference speed and accuracy. In some embodiments, the model training engine 112 can receive a pre-trained model, upon which it can further improve. For instance, a business can upload to the system 102 a model that it has previously trained and optimized for its specific operations.

Application developing engine 114 is configured to develop software that implements computer vision applications for real-world deployments. According to the embodiments, the application development engine 114 generates software applications that combine computer vision functions (e.g., object detection, facial detection, etc.) with implementation-specific logic in order to glean useful insight from various formats of image and/or video data that are typically collected from deployed cameras. Examples of formats for image and video that the system's 102 software applications support can include but are not limited to: Real-Time Streaming Protocol (RTSP); Real-Time Transport Protocol (RTP); Transmission Control Protocol (TCP); several standards for CCTV/surveillance cameras; webcam video; Camera Serial Interface (CSI), GStreamer; Jetson Camera Stream; and the like. The application developing engine 114 has the capability to make determinations on certain aspects that are essential to building a software application, such as ecosystem, environment, language, and logic.

The application developing engine 114 can leverage Application Programming Interfaces (APIs) for the development of software applications that are robust and have flexibility. That is, the application developing engine 114 has the capability to specifically customize a software application to provide real-time insight (using computer vision) in a manner that is deemed optimal for the specific needs of the business. For example, application developing engine 114 can generate a software application that includes computer vision capabilities, such as facial detection, object detection, and object tracking, that are particularly adapted for an enterprise that is experiencing inventory shortages. The application can integrate the computer vision capabilities with other functionality, including but not limited to sending alerts, recording date and time of events, counting object, and defining areas of interest in order to generate actionable insights. Examples of computer vision capabilities that can be implemented by the application developing engine 114 include: facial detection; object detection; object tracking; object counting; package detection; pose estimation; barcode detection; QR code detection; capacity detection; and the like.

Examples of computer vision-based software applications that can be generated by the application developing engine 114 can include, but are not limited to: retail applications (e.g., occupancy counting, speed of service, foot traffic analytics, frictionless checkout, etc.); restaurant applications (e.g., behind-the-counter operations, speed of service, occupancy counting, drive-thru analytics, etc.); manufacturing applications (e.g., package tracking, defect detection, safety alerts, volumetric space detection, etc.); construction applications (e.g., safety alerts, materials delivery notifications, people counting, confined space monitoring, progress tracking, etc.); and venue applications (e.g., people counting, customer dwell time, sponsorship analytics, safety alerts). In some embodiments, the application developing engine 114 has access to a full library of APIs that can be employed to create the computer vision software applications.

Deployment engine 116 is configured to deploy the software applications to the edge or the cloud. For instance, after a computer vision-based software application has been completely developed by the application engine 114, then the deployment engine 116 can deploy the application to an edge device, on premise server, or the cloud to be easily accessible to the end user, namely a business or enterprise. In some embodiments, the deployment engine 116 can implement flexible deployments. For example, the computer vision models and software applications that are generated by the system 102 can be deployed for either on-site (e.g., local) or remote management. Also, the deployment engine 114 can be configured to implement several functions and features associated with deployment and management including: device provisioning; application management; pushing to the cloud; pushing software applications to multiple devices; viewing application logs; device statistics; tracking current software application performance; remote access to devices; data encryption; and automatic starting on reboot (e.g., recovery). Accordingly, the end-to-end enterprise computer vision system 102 implements an end-to-end AI platform for its users using a cloud computing model, for instance providing computer vision-based software to enterprises as a software as a Service (Saas) solution that is suitable for businesses of all sizes (e.g., eliminating IT challenges associated with software and computer resource maintenance for the businesses).

Run-time inferencing engine 118 is configured to utilize AI-based inference to process incoming image and video data in real-time, for instance applying the computer vision model as defined by the deployed software application. Run-time inference can involve the deployed application (deployed by deployment engine 116), leveraging the AI-based learned capabilities of the model (trained by the model training engine 112) to new image and video data in order to achieve the programmed computer vision functions. The software application may be configured to run the run-time inferencing engine 118 at the deployment point, such as the edge device or the cloud, where the software is programmed to utilize the trained model to execute inference on new data, which ultimately drives the computer vision capability (e.g., facial recognition, object detection, etc.) that the model was trained to perform. As an example, a business may have previously installed cameras at a site (e.g., warehouse) that capture video of the location in real-time and feed the newly captured video data to the system 102. Continuing with this example, the software application that has been deployed for that particular business can manage running the run-time inferencing engine 118, where the inference engine applies its trained AI-based model to use inference in order to detect objects that are present in the newly captured video of the business' site, in accordance with the model previously learning to predict the presence of certain objects (i.e., object detection-computer vision function) in each frame. By applying AI-based inference, the run-time inferencing engine 118 is capable of supporting various computer vision capabilities (e.g., capabilities learned by the trained model) that include, but are not limited to: image classification (i.e., is a specific object in each frame of video data); labeling objects; total object count (e.g., in each frame of video data); determine associations across multiple frames (e.g., dwell times). The inference engine generates data about each image, and sends that to the deployed application for further actions or to the analytics engine 119 for analysis.

Analytics engine 119 is configured to derive analytics and other forms of critical insight from executing the computer vision application. In some implementations, the analytics engine receives event-based data that has been exported from the run-time inferencing engine 118 managed by the computer vision software application, and then processes the event-based data to glean analytics data that may provide insight into the overall performance of a business or enterprise. Event-based data can include a packet of information with a timestamp and an associated defined event, such as “person detected.” The event-based data may be processed and communicated in a language independent format, such as JSON, and then visualized in a dashboard, such as Tableau, Kibana, Grafana, and the like. Accordingly, the analytics engine 119 can be configured to generate analytics dashboards and other analytics tools that visually/graphically presents information in a manner that allows the analytics derived from compute vision applications to be usefully and intelligibly consumed by businesses, for instance identifying inefficiencies, anomalies, and productivity issues that may be impacting the enterprise. In some implementations, an API may integrate the ability to directly send analytics information to a console, which allows an end user (e.g., business) to access and view analytics on their devices without complex configuration.

Consequently, the end-to-end enterprise computer vision system 102 disclosed herein implements enterprise-grade computer vision applications at a high level of automation, efficiency, and accuracy, and allows businesses to collect robust, real-time, actionable analytics from AI-based computer vision in a manner that realizes improved operations (e.g., by identifying persistent problems for a business) and increased revenue.

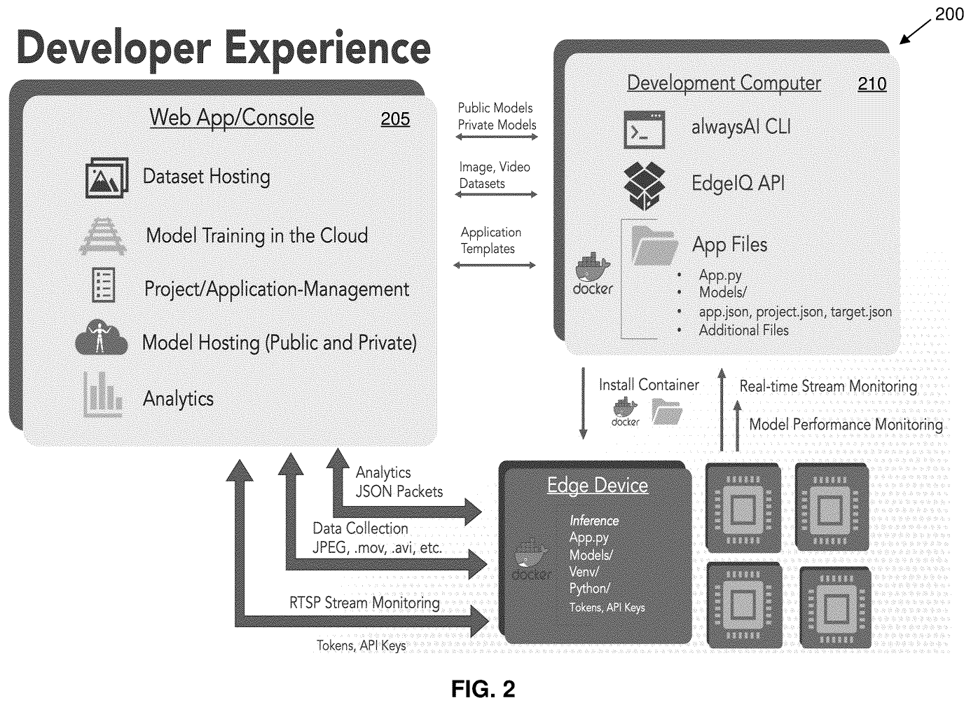

FIG. 2 depicts an example computing environment 200 illustrating a developer experience that can be related to the development and deployment of software applications implemented by the end-to-end enterprise computer vision system (shown in FIG. 1). The developer experience (DevX) shown in FIG. 2 can be encountered during building, deploying, and maintaining software applications on a cloud-based platform. As seen in FIG. 2, the computing environment 200 can include a web application/console 205, development computer 210, and edge device 215 that each are components involved in implementing various aspects of the development process for a cloud-based software application.

The web application/console 205 can be user interfaces provided by a cloud service provider to enable users, administrators, and developers to interact with and manage the cloud resources and services. In the example of FIG. 2, the web application/console 205 is configured to support several functions related to computer vision applications including: dataset hosting; model training in the cloud; project/application-management; model hosting (public and private); and analytics.

The development computer 210 can be a computer device used by a software developer to design, code, test, and debug the software applications. For example, development work can take place on the development computer 210 to design the software application before deploying the application to the cloud. In the example of FIG. 2, the development computer 210 is configured to support development related components including: Command Line Interface (CLI), APIs, and app files. As described herein, the software applications that are developed at the development computer 210 implement various AI-based computer vision functions that can realize improved operations for businesses and enterprises.

The edge device 215 can be a hardware resource (e.g., GPU module, personal computer, server, etc.) that is located on a network or computing infrastructure located at the target environment. For example, after a software application for computer vision is developed on the development computer 210, it can be deployed to the edge device 215 in order to be executed and managed by end-users via commands communicated over the cloud. In the example of FIG. 2, the edge device 215 is configured to implement various components and libraries related to a deployed software application including: virtual environments (e.g. Docker); AI-based models; tokens; and API streams; and the like. These components enable the deployed application to perform various functions, including computer vision inferencing, analytics broadcasting, data collection, and performance monitoring.

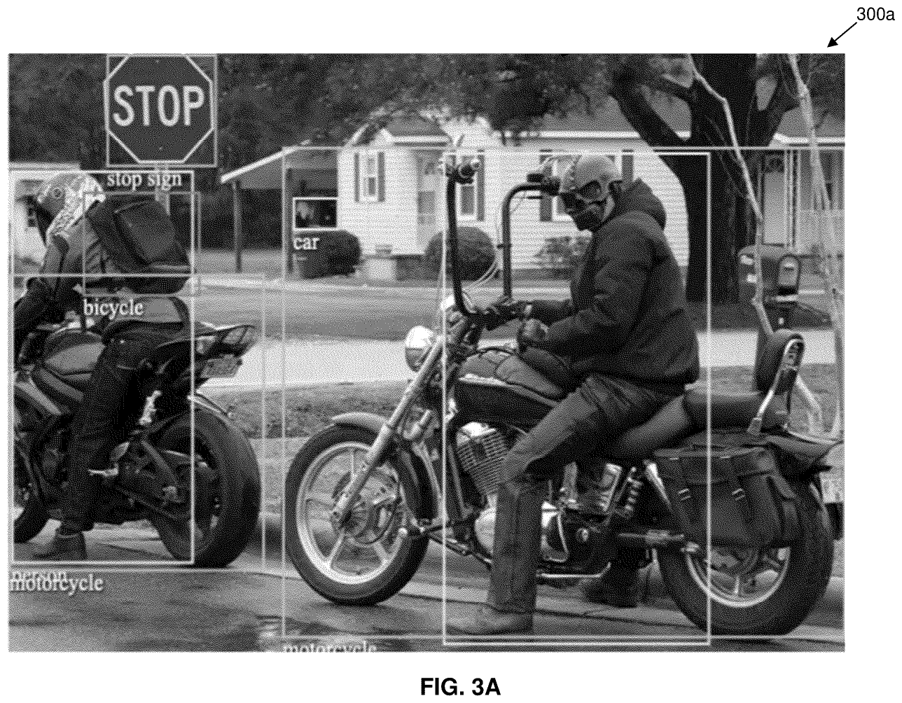

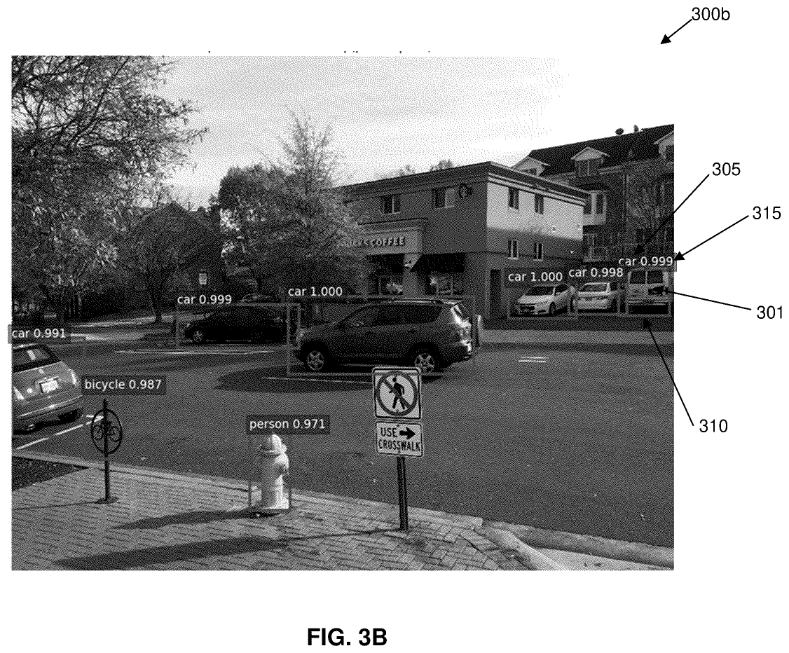

FIG. 3A illustrates an example of image data 300a that can be used in training an AI-based model implemented by the end-to-end enterprise computer vision 102 shown in FIG. 1, in accordance with some of the embodiments disclosed herein. As an example, the image data 300a can be a frame from real-time video captured of a street environment, which is utilized in training a model to perform a computer vision function, namely object detection. Training the model can involve analyzing video data frame-by-frame, for instance analyzing the frame of image data 300a, in order to train the computer vision model (e.g., neural network) on that image. As seen in FIG. 3A, the image data 300a has identified several different objects of interest that are present within the street environment such as cars, people, motorcycles, signs, and the like. These objects are defined with a bounding box and associated label. Similarly, the output from training a model for object detection may be a list of objects that it has detected, where each object in the list has a corresponding label, bounding box, and confidence level. Thus, the example of FIG. 3B illustrates the outputs in an image 300b from model training in relation to the image data 300a shown in FIG. 3A that can be in the training dataset. As seen, each object detected in the image 300b is within a bounding box and has a corresponding label and confidence level that has also been determined by training the model. Examples of object labels shown in FIG. 3B include “car”, “bicycle”, and “person.” In particular, FIG. 3B depicts an object 301, shown as a parked automobile, that has been detected during the model training process, where the results also include a bounding box 310 around the perimeter of the object 301 in the image 300b, a label 305 of “car”, and a confidence level 315 of “0.999”.

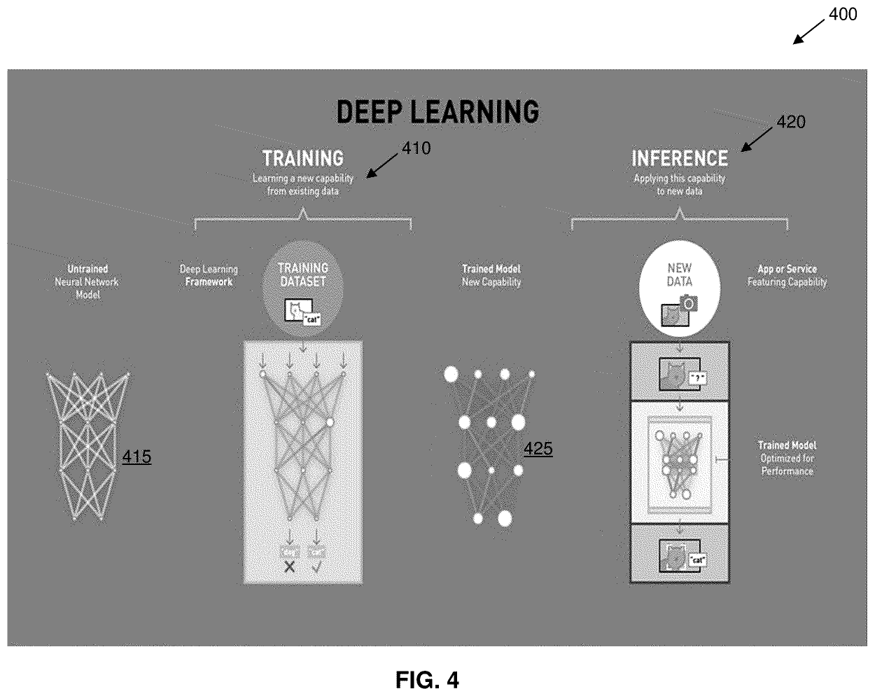

FIG. 4 is a conceptual diagram depicting two phases in the lifecycle of a neural network model that can be employed by the end-to-end enterprise computer vision system 102 shown FIG. 1. In particular, FIG. 4 illustrates training phase 410 of an untrained neural network model 415 and the inference phase 420 of the trained neural network model 425. During the training phase 410, the untrained neural network 415 learns from an existing training dataset, such as images and video. The training phase 410 can be executed in the cloud, in some implementations. The network 415 adjusts its internal parameters (e.g., weights and biases) through an optimization process, where training aims to teach the untrained neural network model 415 to perform a computer vision function, such as object detection, using samples in the dataset, and ultimately build predictive capabilities in performing the computer vision function on new unseen data.

The inference phase 420 applies the trained neural network model 425 in practical use. The inference phase 420 can be executed by the deployed software application running at the edge device, in some implementations. During the inference phase 420 new unseen data is received as input, for instance a real-time video stream, and the data is processes it through the trained neural network model 425 that has learned to perform the computer vision function, such as object detection, and produces predictions or classifications. In other words, inference is applying the knowledge gained by the trained neural network model 425 (which is optimized for high performance) during the training phase 410, in order to make predictions on new real-world data.

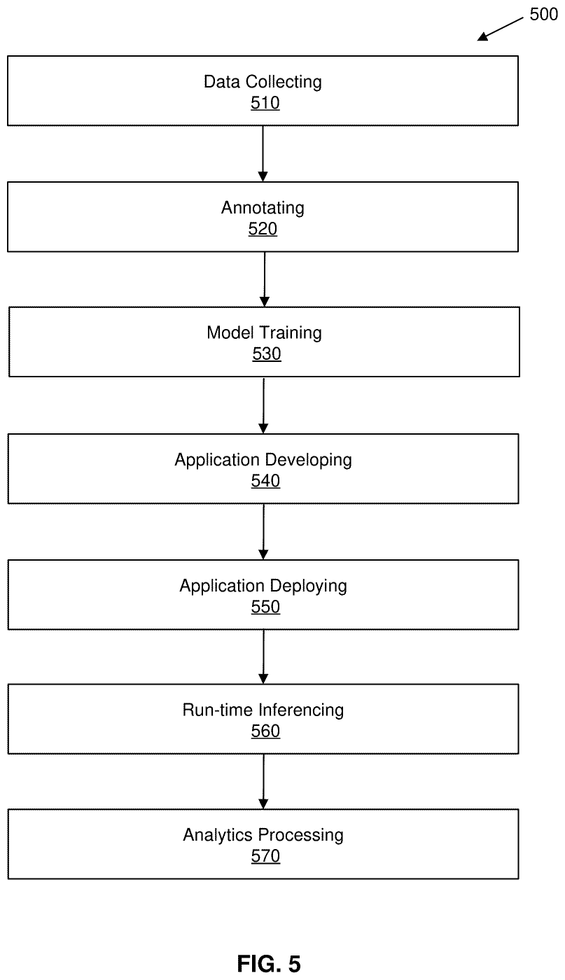

FIG. 5 illustrates an end-to-end enterprise computer vision method, in accordance with some of the embodiments disclosed herein. For example, the end-to-end enterprise computer vision system 102 illustrated in FIG. 1 may execute machine readable instructions by processor 104 to perform the functions described herein.

At block 510, data collection is performed. For example, images or videos from a deployment location associated end user (e.g., business) can be collected by its own cameras and uploaded to the system.

At block 520, annotation is performed. Block 520 can involve highlighting and annotating/labeling the objects or items to detect in the data that is collected in previous block 510. Thus, block 520 results in an annotated dataset that can be employed in training an AI-based model.

Subsequently, at block 530, model training is performed. An AI-based model can be trained based on the annotated dataset from previous block 520. For example, the model can be trained to perform several computer vision functions, such as object detection, facial recognition, object tracking, and the like.

At block 540, application developing is performed. A software application can be developed to perform a computer vision function. In some cases, the developed software application is built on the cloud using a library of APIs, and leveraging the learned capabilities of the AI-based model trained in previous block 530.

Next, at block 550, application deployment is performed. Block 550 can involve deploying the software application that was developed in previous block 540 to an edge device or the cloud.

At block 560, run-time inferencing is performed. Block 560 includes processing the new incoming data at the deployed computer vision application. In other words, inference involves applying the knowledge learned by the trained model in real-time, while running the deployed software application on new image and video data. For example, block 560 can involve an object detection application using AI-based inference to predict/identify which objects are present in frames of a real-time video stream.

At block 570, analytics processing is performed. Block 570 can leverage results, including event-based data, obtained from running the computer vision application in previous block 560 to derive analytics and other insight information. Accordingly, the method 500 implements a distinct end-to-end enterprise computer vision process that implements enterprise-level models and applications to capture real-time actionable insight from image data in a manner that can improve operations and increase revenue for a business or enterprise.

The processes may be implemented by a computer system. The computer system may include a bus or other communication mechanism for communicating information, one or more hardware processors coupled with the bus for processing information. The hardware processor(s) may be, for example, one or more general purpose microprocessors.

The computer system also includes a main memory, such as a random access memory (RAM), cache and/or other dynamic storage devices, coupled to the bus for storing information and instructions to be executed by the processor. The main memory also may be used for storing temporary variables or other intermediate information during execution of instructions to be executed by the processor. Such instructions, when stored in storage media accessible to the processor, render the computer system into a special-purpose machine that is customized to perform the operations specified in the instructions.

The computer system further includes a read only memory (ROM) or other static storage device coupled to the bus for storing static information and instructions for the processor. A storage device, such as a magnetic disk, optical disk, or thumb drive, may be coupled to the bus for storing information and instructions.

The computer system may be coupled via the bus to a display, such as a liquid crystal display (LCD), for displaying information to a computer user. An input device, including alphanumeric and other keys, is coupled to the bus for communicating information and command selections to the processor. Another type of user input device is a mouse, a trackball, or cursor direction keys for communicating direction information and command selections to the processor and for controlling cursor movement on the display. In some embodiments, the same direction information and command selections as cursor control may be implemented via receiving touches on a touch screen without a cursor.

The computing system may include a user interface module to implement a GUI that may be stored in a mass storage device as executable software codes that are executed by the computing device(s). This and other modules may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables.

In general, the word “component,” “engine,” “system,” “database,” data store,” and the like, as used herein, can refer to logic embodied in hardware or firmware, or to a collection of software instructions, possibly having entry and exit points, written in a programming language, such as, for example, Java, C or C++. A software component may be compiled and linked into an executable program, installed in a dynamic link library, or may be written in an interpreted programming language such as, for example, BASIC, Perl, or Python. It will be appreciated that software components may be callable from other components or from themselves, and/or may be invoked in response to detected events or interrupts. Software components configured for execution on computing devices may be provided on a computer readable medium, such as a compact disc, digital video disc, flash drive, magnetic disc, or any other tangible medium, or as a digital download (and may be originally stored in a compressed or installable format that requires installation, decompression or decryption prior to execution). Such software code may be stored, partially or fully, on a memory device of the executing computing device, for execution by the computing device. Software instructions may be embedded in firmware, such as an EPROM. It will be further appreciated that hardware components may be comprised of connected logic units, such as gates and flip-flops, and/or may be comprised of programmable units, such as programmable gate arrays or processors.

The computer system may implement the techniques described herein using customized hard-wired logic, one or more ASICs or FPGAs, firmware and/or program logic which in combination with the computer system causes or programs the computer system to be a special-purpose machine. According to one embodiment, the techniques herein are performed by the computer system in response to the processor(s) executing one or more sequences of one or more instructions contained in the main memory. Such instructions may be read into the main memory from another storage medium. Execution of the sequences of instructions contained in the main memory causes the processor(s) to perform the process steps described herein. In alternative embodiments, hard-wired circuitry may be used in place of or in combination with software instructions.

The term “non-transitory media,” and similar terms, as used herein refers to any media that store data and/or instructions that cause a machine to operate in a specific fashion. Such non-transitory media may comprise non-volatile media and/or volatile media. Non-volatile media includes, for example, optical or magnetic disks. Volatile media includes dynamic memory. Common forms of non-transitory media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, an EPROM, a FLASH-EPROM, NVRAM, any other memory chip or cartridge, and networked versions of the same.

Non-transitory media is distinct from but may be used in conjunction with transmission media. Transmission media participates in transferring information between non-transitory media. For example, transmission media includes coaxial cables, copper wire and fiber optics, including the wires that comprise a bus. Transmission media can also take the form of acoustic or light waves, such as those generated during radio-wave and infra-red data communications.

The computer system also includes a communication interface coupled to the bus. The interface provides a two-way data communication coupling to one or more network links that are connected to one or more local networks. For example, the interface may be an integrated services digital network (ISDN) card, cable modem, satellite modem, or a modem to provide a data communication connection to a corresponding type of telephone line. As another example, the interface may be a local area network (LAN) card to provide a data communication connection to a compatible LAN (or WAN component to communicated with a WAN). Wireless links may also be implemented. In any such implementation, the interface sends and receives electrical, electromagnetic or optical signals that carry digital data streams representing various types of information.

A network link typically provides data communication through one or more networks to other data devices. For example, a network link may provide a connection through local network to a host computer or to data equipment operated by an Internet Service Provider (ISP). The ISP in turn provides data communication services through the world wide packet data communication network now commonly referred to as the “Internet.” Local network and Internet both use electrical, electromagnetic or optical signals that carry digital data streams. The signals through the various networks and the signals on network link and through an interface, which carry the digital data to and from the computer system, are example forms of transmission media.

The computer system can send messages and receive data, including program code, through the network(s), network link and interface. In the Internet example, a server might transmit a requested code for an application program through the Internet, the ISP, the local network and the interface.

The received code may be executed by the processor as it is received, and/or stored in the storage device, or other non-volatile storage for later execution.

Each of the processes, methods, and algorithms described in the preceding sections may be embodied in, and fully or partially automated by, code components executed by one or more computer systems or computer processors comprising computer hardware. The one or more computer systems or computer processors may also operate to support performance of the relevant operations in a “cloud computing” environment or as a “software as a service” (Saas). The processes and algorithms may be implemented partially or wholly in application-specific circuitry. The various features and processes described above may be used independently of one another, or may be combined in various ways. Different combinations and sub-combinations are intended to fall within the scope of this disclosure, and certain method or process blocks may be omitted in some implementations. The methods and processes described herein are also not limited to any particular sequence, and the blocks or states relating thereto can be performed in other sequences that are appropriate, or may be performed in parallel, or in some other manner. Blocks or states may be added to or removed from the disclosed example embodiments. The performance of certain of the operations or processes may be distributed among computer systems or computers processors, not only residing within a single machine, but deployed across a number of machines.

As used herein, a circuit might be implemented utilizing any form of hardware, software, or a combination thereof. For example, one or more processors, controllers, ASICs, PLAS, PALs, CPLDs, FPGAs, logical components, software routines or other mechanisms might be implemented to make up a circuit. In implementation, the various circuits described herein might be implemented as discrete circuits or the functions and features described can be shared in part or in total among one or more circuits. Even though various features or elements of functionality may be individually described or claimed as separate circuits, these features and functionality can be shared among one or more common circuits, and such description shall not require or imply that separate circuits are required to implement such features or functionality. Where a circuit is implemented in whole or in part using software, such software can be implemented to operate with a computing or processing system capable of carrying out the functionality described with respect thereto.

As used herein, the term “or” may be construed in either an inclusive or exclusive sense. Moreover, the description of resources, operations, or structures in the singular shall not be read to exclude the plural. Conditional language, such as, among others, “can,” “could,” “might,” or “may,” unless specifically stated otherwise, or otherwise understood within the context as used, is generally intended to convey that certain embodiments include, while other embodiments do not include, certain features, elements and/or steps.

Terms and phrases used in this document, and variations thereof, unless otherwise expressly stated, should be construed as open ended as opposed to limiting. Adjectives such as “conventional,” “traditional,” “normal,” “standard,” “known,” and terms of similar meaning should not be construed as limiting the item described to a given time period or to an item available as of a given time, but instead should be read to encompass conventional, traditional, normal, or standard technologies that may be available or known now or at any time in the future. The presence of broadening words and phrases such as “one or more,” “at least,” “but not limited to” or other like phrases in some instances shall not be read to mean that the narrower case is intended or required in instances where such broadening phrases may be absent.

What is claimed is:

1. An end-to-end enterprise computer vision system comprising:
a memory; and
a processor that is configured to execute machine readable instructions stored in the memory for causing the processor to:
develop a software application performing one or more computer vision functions; and
process analytics from the one or more computing vision functions, wherein the analytics provide real-time insight associated with operations of an enterprise.

2. The system of claim 1, wherein the software application performs one or more computer vision functions on image data or video data related to the enterprise received in real-time.

3. The system of claim 2, wherein the computer vision functions comprise one or more of: facial detection, object detection, object tracking, and object counting.

4. The system of claim 2, wherein the software application is deployed to an edge device.

5. The system of claim 4, wherein the processor that is configured to execute machine readable instructions stored in the memory further causes the processor to:
collect image data and video data from one or more deployment locations associated with the enterprise;
annotate the collected image data and video data to generate a training dataset;
train an Artificial Intelligence (AI)-based model using the training dataset;
deploy the software application to the edge device; and
execute the deployed software application, wherein executing the deployed software application comprises performing run-time inference on the image data or video data related to the enterprise received in real-time.

6. The system of claim 5, wherein training the AI-based model is performed on a cloud resource.

7. The system of claim 6, wherein performing run-time inference is based on the trained AI-based model.

8. An end-to-end enterprise computer vision method, comprising:
developing a software application performing one or more computer vision functions; and
processing analytics from the one or more computing vision functions, wherein the analytics provide real-time insight associated with operations of an enterprise.

9. The method of claim 8, further comprising:
collecting image data and video data from one or more deployment locations associated with the enterprise;
annotating the collected image data and video data to generate a training dataset;
training an Artificial Intelligence (AI)-based model using the training dataset;
deploying the software application to an edge device; and
executing the deployed software application, wherein executing the deployed software application comprises performing run-time inference on the image data or video data related to the enterprise received in real-time.

10. The method of claim 9, wherein performing run-time inference is based on the trained AI-based model.
